(19) United States
(12) Patent Application Publication
(10) Pub. No.: US 2015/0365348 A1
(43) Pub. Date: Dec. 17, 2015

(54) SYSTEM, METHOD, SERVER SYSTEM, AND STORAGE MEDIUM

(71) Applicant: CANON KABUSHIKI KAISHA, Tokyo (JP)

(72) Inventor: Kotaro Matsuda, Kawasaki-shi (JP)

(21) Appl. No.: 14/737,234

(22) Filed: Jun. 11, 2015

(30) Foreign Application Priority Data
Jun. 13, 2014 (JP) 2014-122538

(51) Int. Cl. H04L 12/927; H04L 29/08

(52) U.S. Cl. CPC H04L 47/808; H04L 67/10

(57) ABSTRACT

When a total of the number of application programming interface calls called from a plurality of clients is less than or equal to an upper limit number of application programming interface calls associated with a user identifier, a client who uses a service by calling the application programming interface is permitted to use a service.

### BACKGROUND

1. Field

Aspects of the present invention generally relate to a system, a method, a server system, and a storage medium which manage access to a resource.

2. Description of the Related Art

Recently, mobile terminals, such as a smartphone and a tablet computer, have been rapidly spread. A mechanism has been provided which enables an application developer to easily open and sell a developed application to these mobile terminals through an application store on the Internet. In addition, Internet service business has been emerged which provides a function which is difficult to be realized by a single mobile terminal in the application development for the mobile terminal as a Web service on the Internet and collects a Web service charge. Especially, a Web service providing form referred to as “backend as a service” (BaaS) has appeared which does not require code development and server operation of a server side and charges only for an amount of use of a Web service application programming interface (API).

When an application is developed and operated using the Web service like BaaS, an application developer concludes a service contract with BaaS. For example, assuming that BaaS provides an API for converting a digital document file which cannot be displayed on the mobile terminal into a digital document file format. An application developer may implement an application to call the API of BaaS when format conversion is required in the application. On the other hand, the format conversion seems to an end user to be a function of the application, and the end user does not need to be aware of the presence of BaaS operating on the back end. The application developer can gain an income, such as an application purchase fee and a usage fee, from the end user via an application store or the like. On the other hand, the application developer needs to pay the Web service charge for an amount used by the distributed application to BaaS. In this regard, Japanese Patent Application Laid-Open No. 2011-70435 discusses a technique for counting the number of requests and limiting the request.

### SUMMARY

According to an aspect of the present invention, a system including a server system provided with a service available from a client and a client who uses the service by calling an application programming interface for using the service includes an authentication unit configured to determine whether the client is an authorized client based on a client identifier assigned to the client, an issuance unit configured to issue authority information indicating that the client has authority to use the service in response to a determination that the client is an authorized client, an authorization unit configured to authorize the client to use the service based on the authority information transmitted by the client when calling the application programming interface, and a storage unit configured to associate the authority information with a user identifier and store the user identifier and an upper limit number of calls of the application programming interface in association with each other, wherein the authorization unit specifies a user identifier associated with the authority information transmitted from the client and permits the client to use the service in a case where a total of the application programming interface calls that a plurality of clients, including the client, called the application programming interface by an instruction from a user corresponding to the user identifier is less than or equal to the upper limit number of application programming interface calls associated with the user identifier.

Further features of the present disclosure will become apparent from the following description of exemplary embodiments with reference to the attached drawings.

### BRIEF DESCRIPTION OF THE DRAWINGS

FIG. 1 illustrates a system configuration and a network configuration according to an exemplary embodiment.

FIG. 2 illustrates a hardware configuration of an information processing function.

FIG. 3 illustrates software configurations of the present system.

FIG. 4 is a tenant management table and a user management table.

FIG. 5 is an API charging menu management table (1), an API charging menu management table (2), and a tenant attribute information management table.

FIGS. 6A and 6B are a client certificate management table, a client management table, an authorization token management table, and an API call number management table.

FIG. 7 is a flowchart illustrating processing of Web service utilization registration.

FIGS. 8A and 8B illustrate a utilization registration screen and an API utilization setting screen.

FIG. 9 is a flowchart illustrating processing of client registration and authorization token issuance (Client Credentials Grant).

FIG. 10 is a flowchart illustrating resource request API processing (1).

FIG. 11 is a flowchart illustrating processing of addition to an upper limit number of API calls.

FIG. 12 illustrates a user interface (UI) for selecting the addition to the upper limit number of API calls and a cost collection selection UI.

FIG. 13 is a flowchart illustrating user registration processing.

FIG. 14 (including FIGS. 14A and 14B) is a flowchart illustrating processing of authorization token issuance (Authorization Code Grant).

FIG. 15 illustrates a login screen, a user registration screen, and an authorization confirmation screen.

FIG. 16 is a flowchart illustrating resource request API processing (2).

### DESCRIPTION OF THE EMBODIMENTS

As an application providing form, one form can be thought which distributes an application for free, limits functions of the application while an end user uses the application for free, and releases the function limitation of the application when the end user purchases a paid function. When the function of the application is realized by an API of BaaS, the function limitation of the application can be released in such a manner that an upper limit number of API usage is set lower while the application is used for free, and the upper limit number of API usage is increased when a fee is paid. There is a mechanism of an application store or the like which automatically allows a single end user who owns a plurality of terminals and purchases an application function by a first terminal to use the same application function by second and subsequent terminals. For example, a case is assumed in which the number of API usage from a terminal is limited to ten times while an application function is used for free, and the upper limit number of API usage is increased up to 300 times after the application function is purchased. As described above, when a single end user owns a plurality of terminals and the application function is available for all terminals with one purchase, there is a following issue. If the upper limit numbers of API usage of the second and subsequent terminals are uniformly increased to 300 times, an API fee for 300 times multiplied by the numbers of the terminals is charged by BaaS. An opportunity for acquiring a fee income from an end user is once when the application function is purchased, and thus a fee burden on the application developer will increase as the number of terminals increase.

The present disclosure is directed to the provision of a mechanism which enables an application developer to easily use an API without impairing convenience of BaaS in a case that a single end user uses a same application function from a plurality of terminals.

Various exemplary embodiments, features, and aspects will be described in detail below with reference to the drawings.

The present exemplary embodiment includes a configuration conforming to OAuth 2.0, which is an Internet standard, to provide a secure API authorization means for an application from the Web service. The API authorization means based on Client Credentials Grant and Authorization Code Grant of OAuth 2.0 are provided. The aforementioned two types of API authorization means are provided to an application for a mobile terminal to identify individual terminals and to make it possible to perform access control on each terminal or each user. An API is an interface to be called to use the Web service.

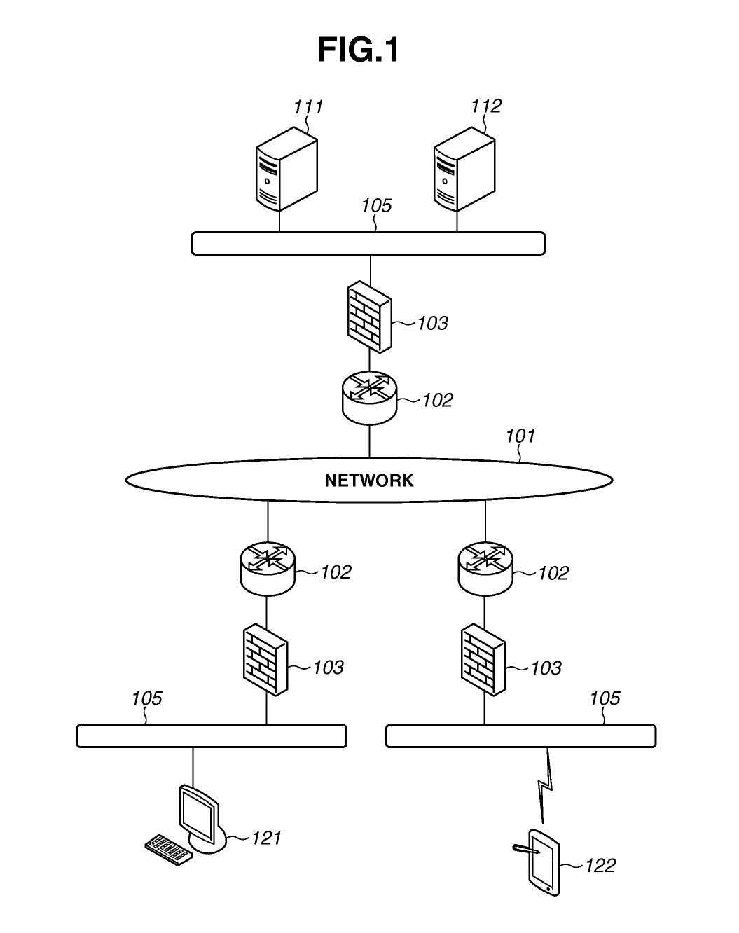

FIG. 1 is an example of a system configuration and a network configuration for implementing an exemplary embodiment. A network 101 is an Internet, an intranet, or the like, and devices connected to the network 101 can communicate with each other. A network device 102, such as a router and a switch, connects networks with each other. A firewall 103 controls communication permission between the networks. A local area network (LAN) 105 is a terminal network to which a device, such as a computer, is connected, and may be a wired communication network or a wireless communication network, such as a wireless LAN and a mobile phone communication network. The system configuration further includes an authorization server 111, a resource server 112, and client computers 121 and 122. The client computers 121 and 122 may include a personal computer, a tablet computer, a smartphone, and the like.

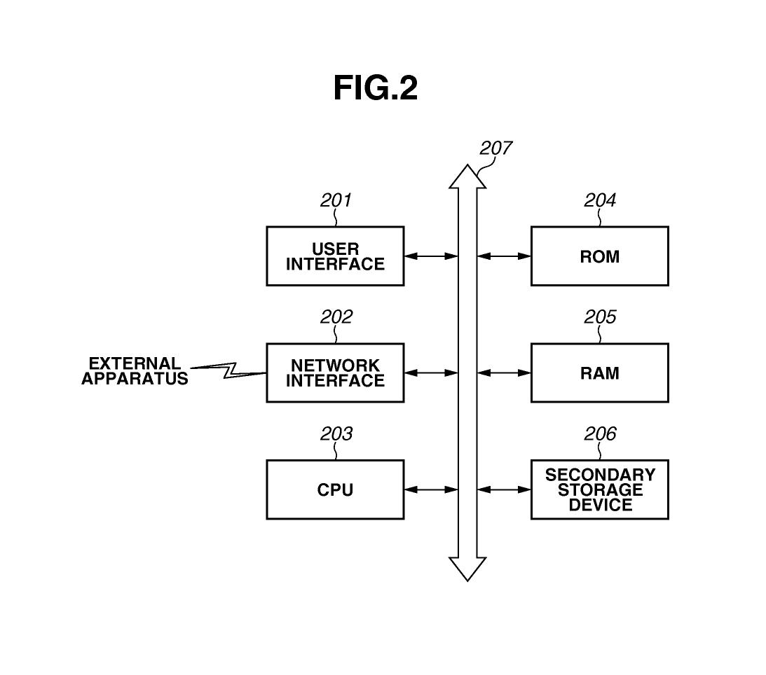

FIG. 2 is a module configuration of information processing functions of the authorization server 111, the resource server 112, and the client computers 121 and 122. A user interface 201 performs input and output of information by a display, a keyboard, a mouse, a touch panel, or the like. A computer which does not include the above-described hardware can be connected to and operated from another computer using a remote desktop, a remote shell, and the like. A network interface 202 connects to a network, such as a LAN, and communicates with other computers and network devices. A read-only memory (ROM) 204 stores an installed program and data. A random access memory (RAM) 205 is a temporary memory area. A secondary storage device 206 is represented by a hard disk drive (HDD). A central processing unit (CPU) 203 executes programs read from the ROM 204, the RAM 205, the secondary storage device 206, and the like. Each unit is connected to each other via an input output interface 207.

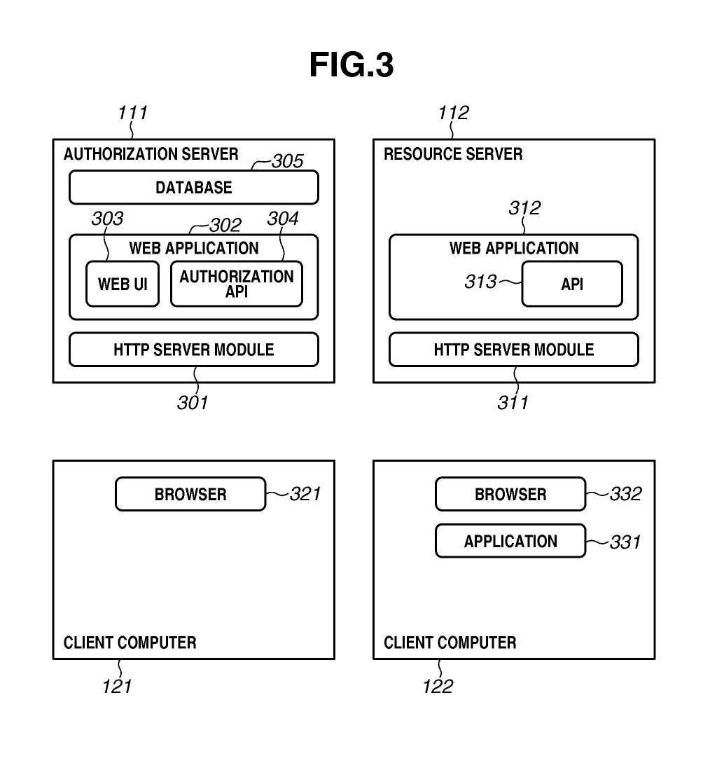

FIG. 3 illustrates a software configuration of the present system. The authorization server 111 includes a HyperText Transfer Protocol (HTTP) server module 301, a Web application 302, and a database 305. The HTTP server module 301 manages and controls communication of request and response of Web access from a client and transfers the request to the Web application 302 if needed. The Web application 302 includes a Web user interface (UI) 303 which provides a Web document in a HyperText Markup Language (HTML) format or the like and an operation screen for a browser and an authorization API 304 which receives authorization processing by the Web service API represented by representational state transfer (REST). The database 305 stores data used by the Web application 302. The database 305 performs addition, reading, updating, and deletion of records in various tables in response to a request from the Web application 302.

The resource server 112 includes an HTTP server module 311 and a Web application 312. The HTTP server module 311 manages and controls communication of request and response of Web access from a client and transfers the request to the Web application 312 if needed. The Web application 312 includes an API 313 which receives various types of processing by the Web service API represented by REST. The API 313 executes processing necessary for a function provided by the resource server, generates a response to an API call request from a client, and returns the response to the client via the HTTP server module 311. The above-described function is referred to as a Web service. Since the resource server can provide various functions, if there is a function that the Web application 312 cannot execute alone, the Web application 312 can request other applications or other servers, which are not illustrated, to execute the function and obtain a response.

The authorization server 111 and the resource server 112 according to the present exemplary embodiment are a server group disposed within a same security domain, and according to the present exemplary embodiment, a server system means including at least two servers, namely the authorization server 111 and the resource server 112. The server system is described using an example which includes a plurality of servers of the authorization server 111 and the resource server 112, however, the server system may include a single server having functions of two servers.

A browser 321 is installed in the client computer 121 and can be executed. The browser 321 receives and displays an HTML Web document or the like and an operation screen provided by the Web UI 303 and transmits an operation result by a user to the Web UI 303. An application 331 and a browser 332 are installed in the client computer 122 and can be executed. The application 331 can use various functions provided by the resource server by accessing the API 313. The browser 332 receives and displays an HTML Web document or the like and an operation screen in a part of authorization operation steps and transmits an operation result by a user to the authorization API 304.

Which module in the configuration illustrated in FIG. 3 corresponds to which role in OAuth 2.0 is described below. The authorization server 111 corresponds to an “Authorization Server” role of OAuth 2.0. The resource server 112 corresponds to a “Resource Server” role of OAuth 2.0. When Client Credentials Grant is used, the application 331 corresponds a “Client” role and a “Resource Owner” role of OAuth 2.0. When Authorization Code Grant is used, the application 331 corresponds a “Client” role of OAuth 2.0. In addition, when Authorization Code Grant is used, a user who uses a function and data of the resource server 112 using the application 331 corresponds to a “Resource Owner” role of OAuth 2.0. In the following descriptions, each module executes an API authorization flow as the above-mentioned role of OAuth 2.0. In addition, a “client” in the specification and the drawings means the application 331 which operates as a request source of the Web service API, such as the authorization API 304 and the API 313, as a “Client” role of OAuth 2.0. Needless to say, the application 331 is included in each terminal, and thus the present system includes a plurality of clients.

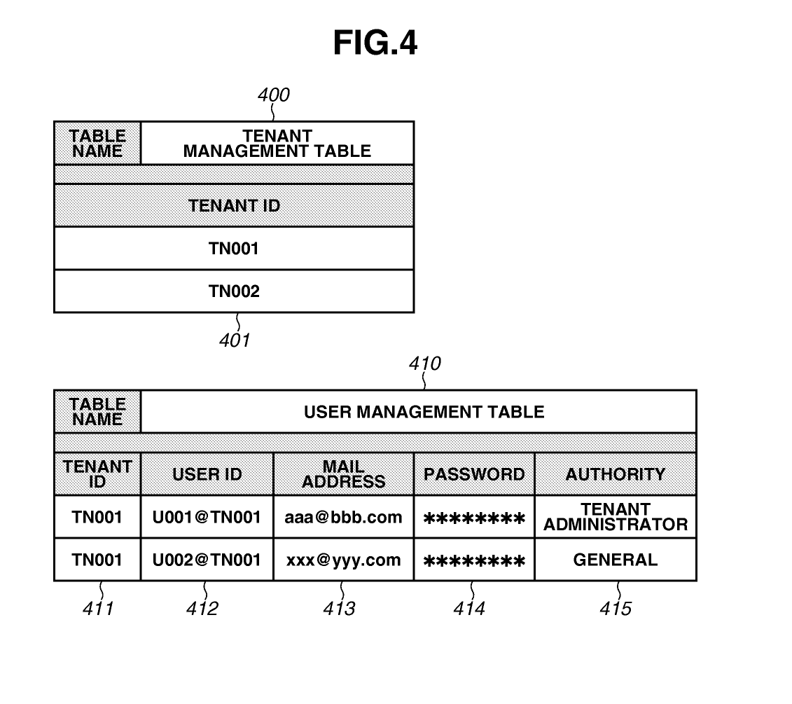

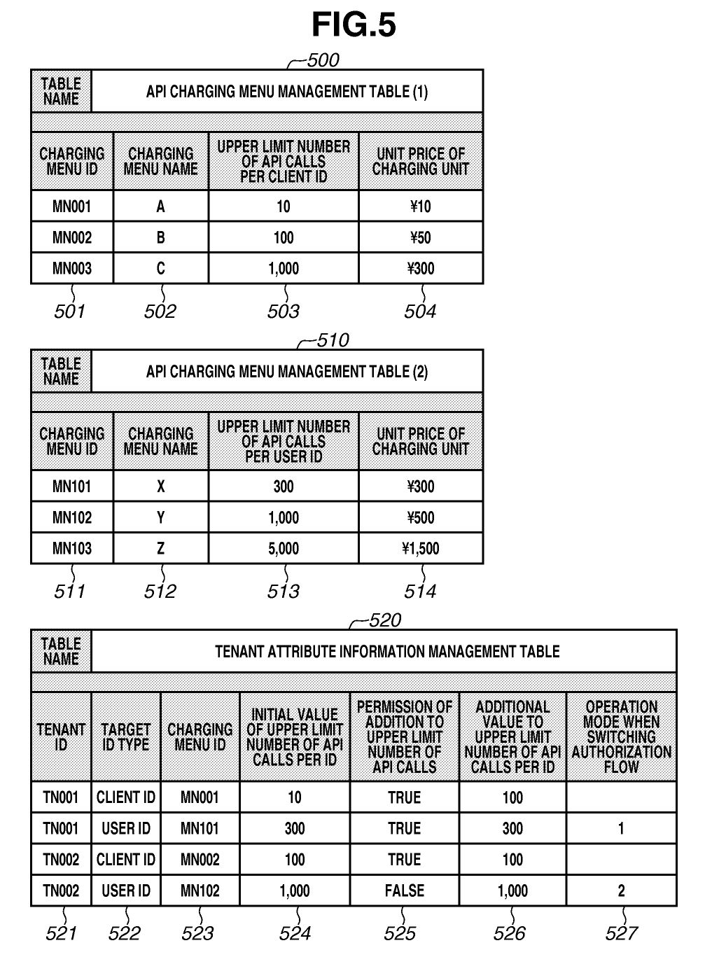

FIGS. 4, 5, and 6 are various tables stored in the database 305 in the authorization server 111. A tenant management table 400 includes a column storing a tenant identification (ID) 401. The tenant ID 401 is a unit for securely separate resources when the Web service provided by the authorization server and the resource server is used by various organizations and individuals. Such a system is generally referred to as a multi-tenant system.

A user management table 410 includes following columns. A column 411 stores a tenant ID to which a user belongs. A column 412 stores a user ID. A column 413 stores a mail address of the user. A column 414 stores a password of the user. A column 415 stored an authority given to the user in the tenant to which the user belongs. Hereinbelow, the columns 411, 412, and 415 are sometimes referred to as the tenant ID 411, the user ID 412, and the authority 415. The authority 415 includes a tenant administrator having an authority with all data pieces in the tenant and a general which is user authority having only a limited authority.

API charging menu management tables 500 and 510 include following columns. Columns 501 and 511 store a charging menu ID. Columns 502 and 512 store a charging menu name. A column 503 stores an upper limit number of API calls per client ID. A column 513 stores an upper limit number of API calls per user ID. Columns 504 and 514 store a unit price of a charging unit. According to the present exemplary embodiment, an example is described in which a right to use the upper limit number of API calls per client ID or per user ID defined in the columns 503 and 513 is converted as one charging unit, and the number of used charging units is charged. However, various charging form can be used, and just one example is described below.

A tenant attribute information management table 520 includes following columns. A column 521 stores a tenant ID. A column 522 stores a target ID type indicating which of a client ID or a user ID the record targets at. A column 523 stores a charging menu ID that the tenant has selected. A column 524 stores an initial value of the upper limit number of API calls per client ID or per user ID. A column 525 stores a setting value of permission/non-permission of addition to the upper limit number of API calls. A column 526 stores a value added to the upper limit number of API calls per client ID or per user ID. A column 527 stores an operation mode when an authorization flow is switched. Hereinbelow, the columns 522, 524, 525, 526, and 527 are sometimes referred to as the target ID type 522, the initial value 524, the permission setting 525, the additional value 526, and the operation mode 527.

A client certificate management table 600 includes following columns. A column 601 stores a serial number of a client certificate. A column 602 stores an issuer of the certificate. A column 603 stores a subjective person of the certificate. A column 604 stores a start date and time of a valid period of the certificate. A column 605 stores an end date and time of the valid period of the certificate. A column 606 stores a tenant master distinguished name (DN). Hereinbelow, the columns 601 and 606 are sometimes referred to as the serial number 601 and the tenant master DN 606.

A client management table 610 includes following columns. A column 611 stores a client ID which is a client identifier for uniquely identifying an application 311 to be a client. A column 612 stores a secret of the client. A column 613 stores a tenant ID to which the client belongs. A column 614 stores a type of the client. The type 614 includes, as a client, a master having an authority to manage the tenant and a general which is client authority having only a limited authority. A column 615 stores a DN of the client. A column 616 stores a redirect uniform resource locator (URL) after authorization confirmation. Hereinbelow, the columns 611, 613, 614, and 615 are sometimes referred to as the client ID 611, the tenant ID 613, the type 614, and the DN 615. An OAuth 2.0 client is individually identified and managed by the client management table 610.

An authorization token management table 620 includes following columns. A column 621 stores a type of a token. A column 622 stores an authorization token ID. A column 623 stores an expiration date of the authorization token. A column 624 stores a refresh token ID. A column 625 stores an expiration date of the refresh token. A column 626 stores a client ID as an issuance target of the authorization token. A column 627 stores an owner ID of an owner of the authorization token. Hereinbelow, the columns 621, 622, 623, 625, 626, and 627 are sometimes referred to as the token type 621, the authorization token ID 622, the expiration date 623, the refresh token expiration date 625, the client ID 626, and the owner ID 627.

An API call number management table 630 includes following columns. A column 631 stores a user ID which is a user identifier for uniquely identifying a user, and one user ID corresponding to one user is stored. A column 632 stores a client ID. A column 633 stores a target period to total the number of API calls. According to the present exemplary embodiment, the number of API calls is totaled up monthly, however, a period of totaling may be other units and periods, such as yearly and weekly. A column 634 stores a setting value of the upper limit number of API calls. A column 635 stores the number of API calls actually called by the client. A column 636 stores a last access date and time when the API was called by the client. Hereinbelow, the columns 631, 632, 633, 634, and 635 are sometimes referred to as the user ID 631, the client ID 632, the target period 633, the setting value 634, and the number of API calls 635.

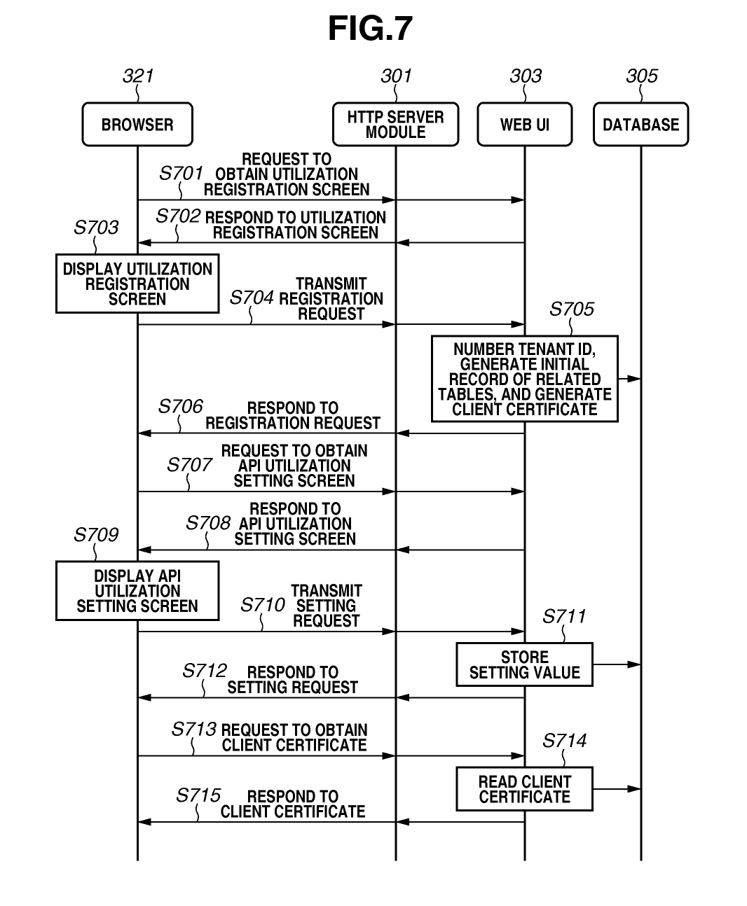

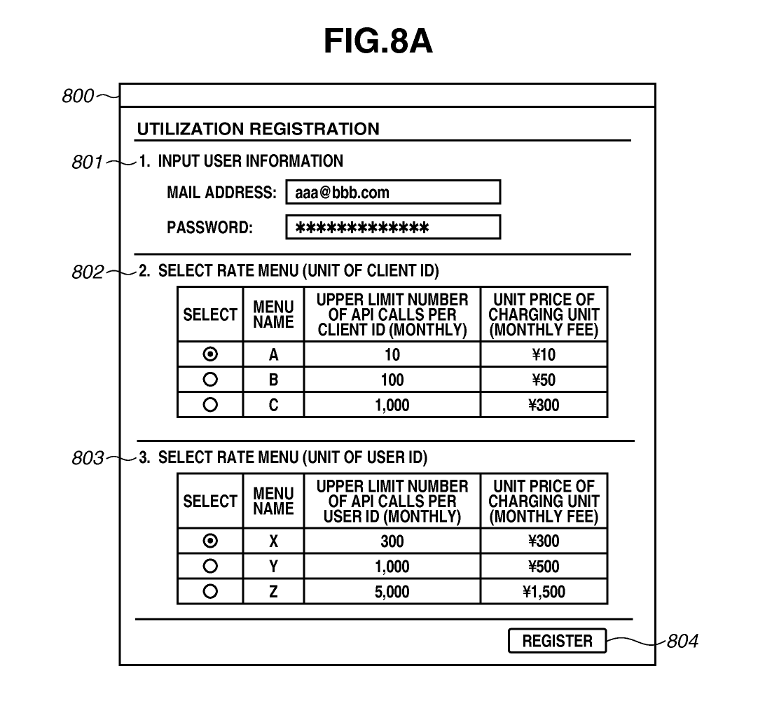

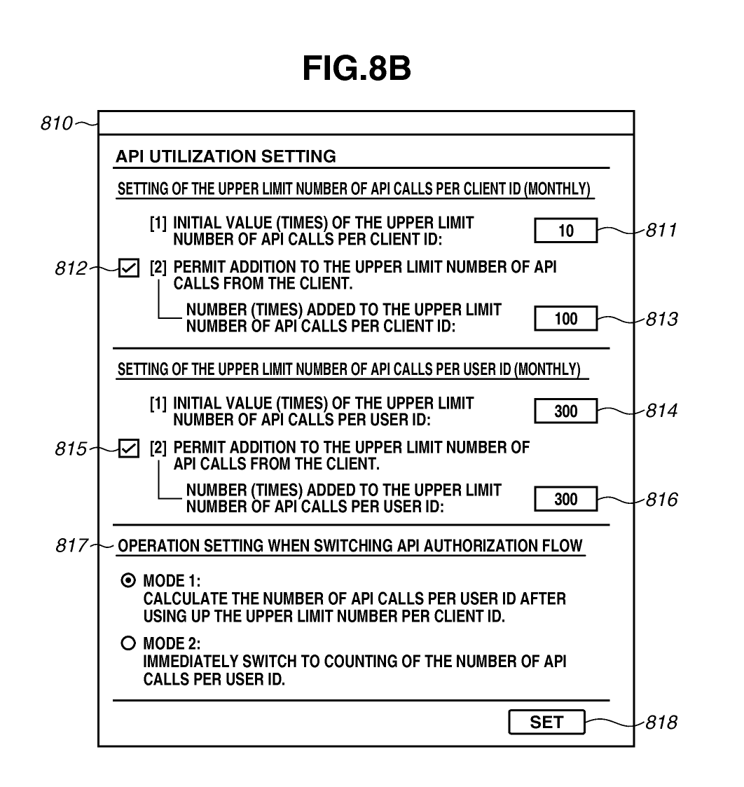

A processing flow for registering to use the Web service provided by the authorization server 111 and the resource server 112 is described below with reference to FIGS. 7, 8A, and 8B. A user who registers to use the Web service is mainly a developer of the application 331. In steps S701, S702, and S703, the user uses the browser 321 to obtain and display a utilization registration screen 800 provided by the Web UI 303. A user information input field 801 is used to input a mail address and a password of the user. Rate menu selection fields 802 and 803 are respectively used to select rate menus of a unit of client ID and of a unit of user ID. The Web UI 303 reads the API charging menu management tables 500 and 510 to offer options of the rate menu selection fields 802 and 803. A registration button 804 is used to transmit a utilization registration request. In step S704, the user inputs the user information in the field 801, selects the rate menu in the fields 802 and 803, and presses the registration button 804, and thus the utilization registration request is transmitted to the Web UI 303.

The Web UI 303 first adds a new tenant ID to the tenant management table 400. The Web UI 303 adds a record of the user to the user management table 410 according to the input user information and adds the tenant administrator to the authority 415. Accordingly, the user can change a setting value and the like of the generated tenant. The Web UI 303 stores the generated tenant ID in the column 521 and the charging menu ID selected in the fields 802 and 803 in the column 523 in the tenant attribute information management table 520. Further, the Web UI 303 stores a type indicating the client ID or the user ID in the column 522 to identify which setting information of the client ID or the user ID. The Web UI 303 generates a client of which type 614 is a master in the client management table 610. Further, in step S705, the Web UI 303 generates a client certificate of which tenant master DN 606 is same as the DN 615 of the generated master client and stores other certificate information pieces in the columns 601, 602, 603, 604, and 605. When these registration processes including the tenant ID, in step S706, the Web UI 303 returns registration completion as a response to the browser 321.

Next, in steps S707, 708, and 709, the browser 321 obtains an API utilization setting screen 810 from the Web UI 303 and displays the screen. A field 811 is used to input an initial value of the upper limit number of API calls per client ID. A check box 812 is used to select permission/non-permission of addition to the upper limit number of API calls per client ID from the client. A field 813 is used to input a value added to the upper limit number of API calls per client ID. A field 814 is used to input an initial value of the upper limit number of API calls per user ID. A check box 815 is used to select permission/non-permission of addition to the upper limit number of API calls per user ID from the client. A field 816 is used to input a value added to the upper limit number of API calls per user ID. A field 817 is used to select a setting when the API authorization flow is switched. A set button 818 is used to transmit an API utilization setting request. When the user inputs and selects each setting value in the API utilization setting screen 810 and presses the set button 818, in step S710, a setting request is transmitted to the Web UI 303.

In step S711, the Web UI 303 stores values input via the API utilization setting screen 810 in the columns 524, 525, and 526 in the tenant attribute information management table 520 for each type of the client ID or the user ID. Further, the Web UI 303 stores the value selected in the selection field 817 in the column 527 for the operation mode when the authorization flow is switched of a record of which target ID type 522 is the user ID. In step S712, the Web UI 303 returns setting completion as a response to the browser 321. Next, in step S713, the browser 321 transmits a client certificate obtaining request to the Web UI 303. In steps S714 and S715, the Web UI 303 reads the client certificate generated as described above and responds to the browser 321.

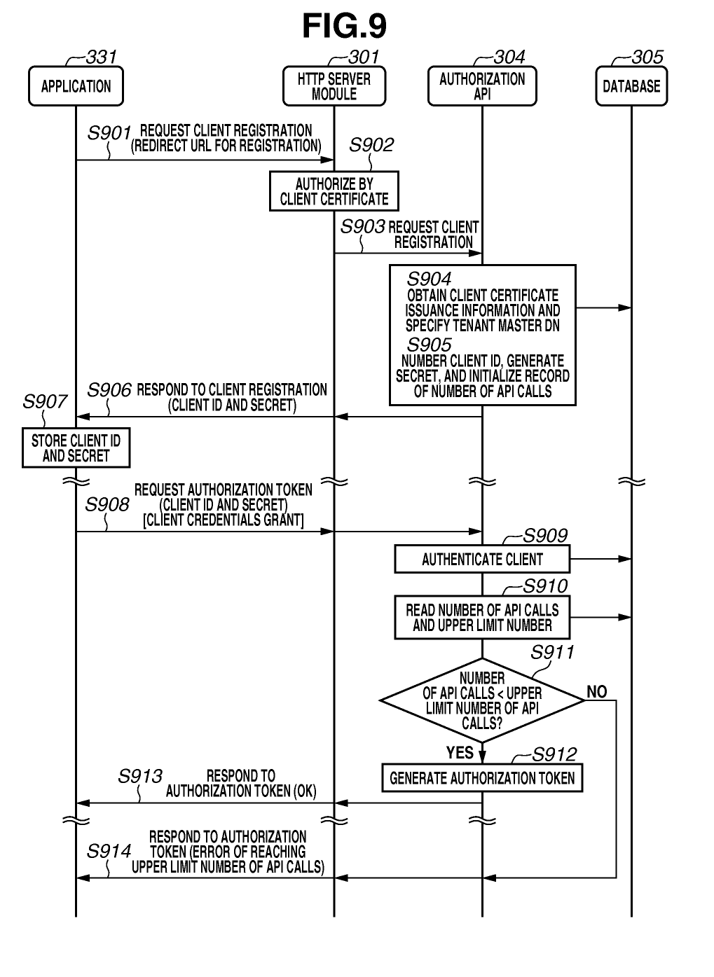

Next, processing flows to register a client and to issue an authorization token based on Client Credentials Grant are described with reference to FIG. 9. The obtained client certificate described above is built into the application 331 in advance by the developer of the application 331, and the application 331 is distributed to the client computer 122. In step S901, the application 331 transmits a client registration request to the HTTP server module 301. The client registration request can include a redirect URL used when an authorization code is issued, which is described below. The HTTP server module 301 requests the client certificate from a calling source in response to the client registration request. In steps S902 and S903, the application 331 transmits the client certificate to the HTTP server module 301, and the HTTP server module 301 transfers the client registration request to the authorization API 304 if the received client certificate is valid.

According to the present exemplary embodiment, the client certificate is used to authenticate the application 331 as an authorized client of the authorization server 111, however, other authentication methods, such as a basic authentication and a digest access authentication can be used. In step S904, the authorization API 304 searches the client certificate management table 600 using the serial number 601 obtained from the received client certificate to specify the tenant master DN 606. Further, the authorization API 304 searches the client management table 610 to obtain a record which includes the DN 615 same as the specified tenant master DN 606.

In step S905, the authorization API 304 verifies that the client type 614 of the obtained record is a master and reads the tenant ID 613. The authorization API 304 adds the record to the client management table, stores a unique ID represented by a Universally Unique Identifier (UUID) assigned to the record in the client ID 611, and stores the read tenant ID in the column 613. Accordingly, a unique identification number is assigned to the application 331. The authorization API 304 also stores a secret which is automatically generated and has a sufficient character string length in the column 612 and stores a general in the client type 614. In addition, when the redirect URL is included in the client registration request, the authorization API 304 stores the redirect URL in the column 616 in the client management table 610. The authorization API 304 adds a record to the API call number management table 630 and stores the assigned client ID in the column 632. The authorization API 304 further stores a current year and month in the column 633 and stores, in the column 634, the initial value 524 of the upper limit number of API calls per client of the relevant tenant of which target ID type 522 set in the tenant attribute information management table 520 is the client ID. The authorization API 304 stores an initial value zero in the column 635.

In step S906, the authorization API 304 returns the generated client ID and the secret as a response to the client registration request to the application 331. In step S907, the application 331 stores the received client ID and secret in a storage area so as to be able to read later. Thus, the processing flow for registering the application 331 to the authorization server 111 as a client has been described, and only an authorized client having the client certificate issued by the authorization server 111 can be registered in the authorization server 111.

In step S908, the application 331 transmits an authorization token request to the authorization API 304 using the obtained client ID and secret. In step S909, the authorization API 304 performs authentication processing to determine whether a request source application is an authorized client by verifying that the received client ID and secret exist and coincide with those in the client management table 610. In step S910, the authorization API 304 searches the API call number management table 630 for the client of which client ID 632 is the client ID of the request source and user ID 631 is NULL and obtains the number of API calls 635 of the current month and the setting value 634 of the upper limit number of API calls. In step S911, the authorization API 304 determines whether the number of API calls 635 of the current month is equal to or less than the setting value 634 of the upper limit number of API calls.

When a determination result in step S911 is YES, in step S912, the authorization API 304 adds a record to the authorization token management table 620 and generates an authorization token. The authorization API 304 respectively stores the authorization token, the assigned authorization token ID, the expiration date of the authorization token, and the client ID of the request source in the columns 621, 622, 623, 626, and 627. In step S913, the authorization API 304 returns the authorization token ID 622 and the expiration date 623 of the generated authorization token to the application 331 as a response. When a determination result in step S911 is NO, in step S914, the authorization API 304 returns an error notifying that the number of API calls reaches the upper limit to the application 331 as a response.

When the authorization token is requested for the first time after the registration of the client ID, the above-described processing in steps S910 and 911 for determining whether the number of API calls reaches the upper limit does not need to be actually performed, and the authorization token may be issued to the application 331. However, the authorization token has the expiration date 623, after expiration of the valid period, the application 331 needs to request another authorization token by performing again the processing in step S908 and subsequent steps. When the authorization token is requested for the second time or later, the above-described processing in steps S910 and 911 for determining whether the number of API calls reaches the upper limit is performed, and if the number of API calls has already reached the upper limit, the authorization token is not issued. The API authorization flow of OAuth 2.0 calls the authorized API using the issued authorization token. The authorization token is authority information for proving that the application 331 as the client has the authority to use the Web service. Thus, when the number of API calls has already reached the upper limit, a call from the application 331 to the API 313 in the resource server 112 is suppressed. Accordingly, effects of reducing a communication traffic to the resource server 112 and CPU processing can be achieved.

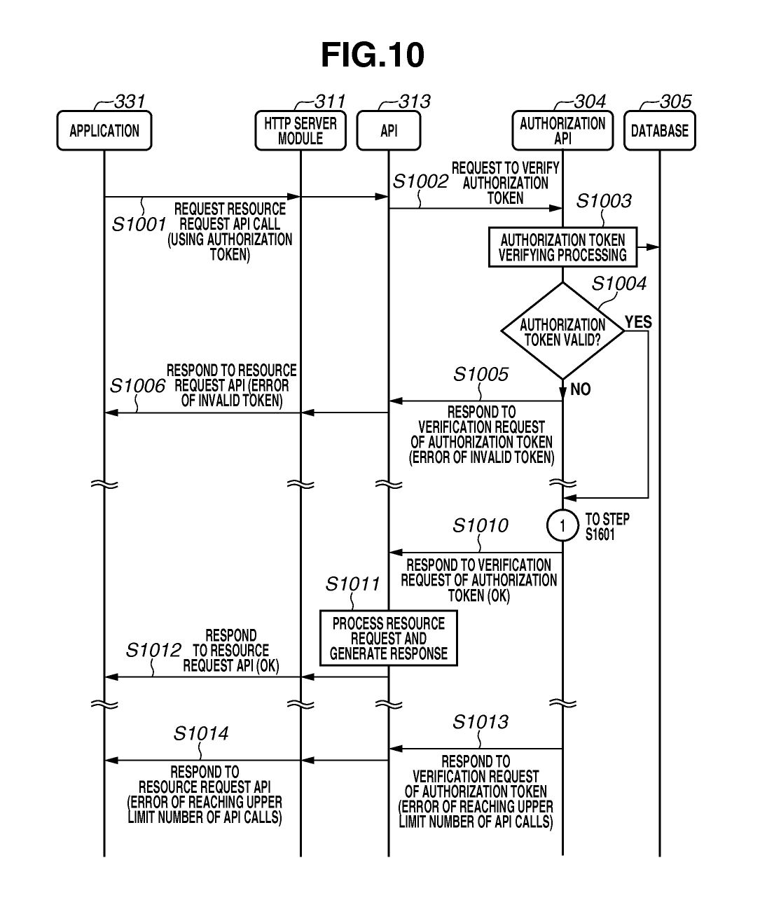

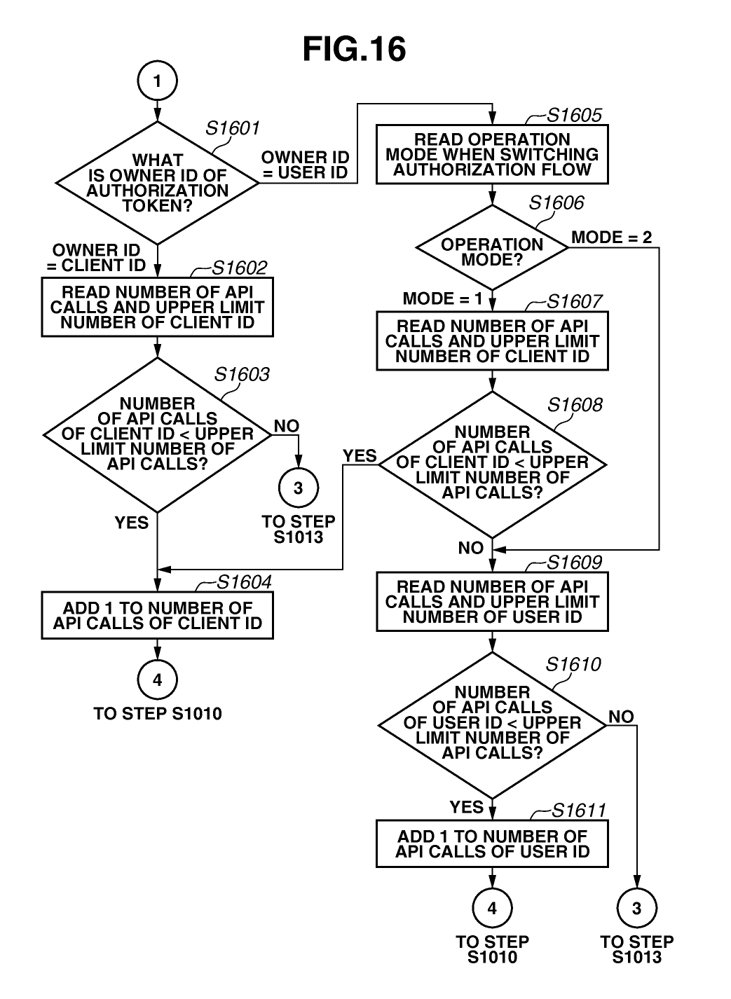

Next, a processing flow for using the API 313 in the resource server 112 using the authorization token obtained in Client Credentials Grant is described with reference to FIGS. 10 and 16. In step S1001, in response to reception of an instruction from a user to start using of the Web service, the application 331 transmits a resource request API call request to the API 313 using the obtained authorization token ID as a parameter. In step S1002, the API 313 transmits a verification request of the received authorization token to the authorization API 304. The authorization API 304 searches the authorization token management table 620 to verify that the authorization token ID of the received authorization token exists in the column 622 and the current date and time is within the expiration date 623. The authorization API 304 further obtains the owner ID 627 of the received authorization token.

Further, in step S1003, the authorization API 304 verifies that the client ID 626 of an issuance destination of the authorization token exists in the client management table 610 to determine that the relevant client ID is valid. In step S1004, the authorization API 304 determines that the received authorization token is valid as a result of the verification processing in step S1003. When a determination result in step S1004 is NO, in step S1005, the authorization API 304 returns an error of invalid token to the API 313 as an authorization token verification result. In step S1006, the API 313 returns the error of invalid token to the application 331 as a response to the resource request API. When a determination result in step S1004 is YES, the processing proceeds to step S1601. In step S1601, the authorization API 304 determines whether the owner ID of the received authorization token is the client ID or the user ID. In the case of Client Credentials Grant, a determination result in step S1601 will be the client ID, and the processing proceeds to step S1602. In step S1602, the authorization API 304 searches the API call number management table 630 for the client ID of the authorization token issuance of which user ID is NULL and obtains the number of API calls 635 of the current month and the setting value 634 of the upper limit number of API calls.

In step S1603, the authorization API 304 determines whether the number of API calls 635 of the current month is equal to or less than the setting value 634 of the upper limit number of API calls. When a determination result in step S1603 is YES, in step S1604, the authorization API 304 adds one to the number of API calls 635 of the current month in the API call number management table 630. In step S1010, the authorization API 304 returns to a success (OK) of the authorization token verification result to the API 313 as a response. In step S1011, the API 313 executes processing of the resource request received in step S1001 to generate a response. In step S1012, the API 313 returns a resource request response generated in step S1011 and a success (OK) of the API call to the application 331 as a response to the resource request API call. When a determination result in step S1603 is NO, in step S1013, the authorization API 304 returns an error indicating that the number of API calls reaches the upper limit to the API 313 as an authorization token verification response. In step S1014, the API 313 returns the error indicating that the number of API calls reaches the upper limit to the application 331 as a response to the resource request API.

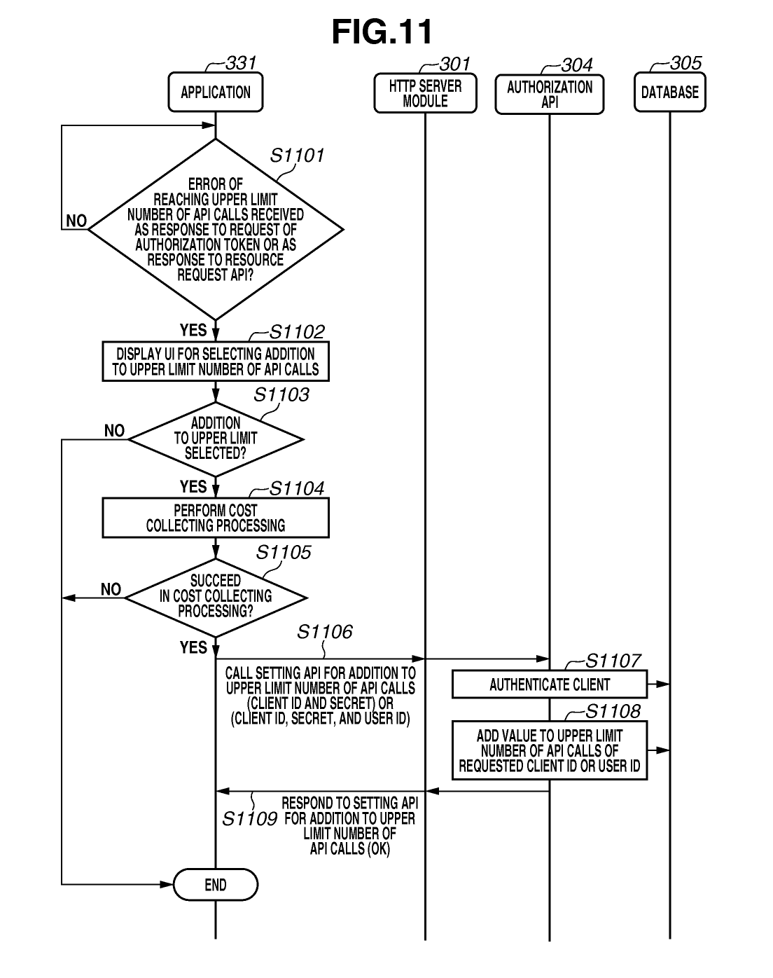

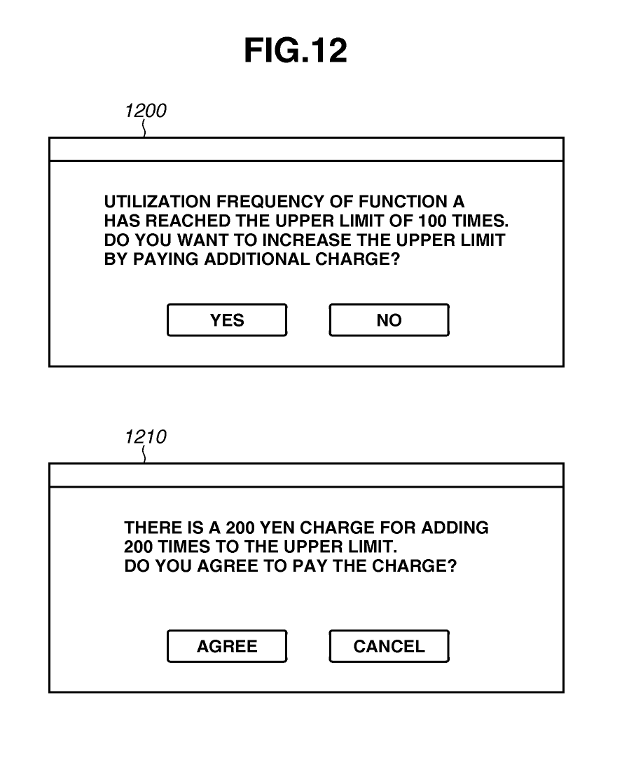

Next, a processing flow for adding a number to the upper limit number of API calls when the number of API calls per client ID reaches the upper limit is described with reference to FIGS. 11 and 12. In step S1101, the application 331 detects that the number of API calls from the client ID of its own has reached the upper limit in the above-described processing in step S914 or step S1014. When it is detected that the number of API calls has reached the upper limit, in step S1102, the application 331 displays a UI 1200 for selecting addition to the upper limit number of API calls. In step S1103, the application 331 determines whether a user selects the addition to the upper limit by the UI 1200. When a determination result in step S1103 is NO, the processing is terminated. When a determination result in step S1103 is YES, in step S1104, the application 331 displays a UI 1210 for performing cost collection processing to ask the user to agree to cost collection regarding the addition to the upper limit.

In step S1105, the application 331 determines whether the user agrees to the cost collection and the cost collection from the user of the application to the developer or the provider of the application has succeeded. When a determination result in step S1105 is NO, the processing is terminated. When a determination result in step S1105 is YES, in other words, the addition to the upper limit number of API calls is permitted, then in step S1106, the application 331 specifies the client ID and the secret with respect to the authorization API 304 to call a setting API for adding a number to the upper limit number of API calls. In step S1107, the authorization API 304 authenticates the request source client as is the case with the processing in step S909.

In step S1108, the authorization API 304 searches the client management table 610 for a record of which client ID 611 coincides with the client ID of the request source and specifies the tenant ID to which the client ID belongs. The authorization API 304 reads a record of which tenant ID and target ID type 522 are the client ID from the tenant attribute information management table 520 and obtains the permission setting 525 of the addition to the upper limit number of API calls. If the permission setting 525 is FALSE, the authorization API 304 returns an error response, which is not illustrated, to the application 331. The authorization API 304 reads the record of the tenant ID in the tenant attribute information management table 520 and obtains the additional value 526 to the upper limit number of API calls per client ID of which target ID type 522 is the client ID. The authorization API 304 obtains a record of which client ID 632 is the client ID of the request source, user ID is NULL, and target period 633 is a current period in the API call number management table 630. The authorization API 304 adds the obtained additional value 526 to the setting value 634 of the upper limit number of API calls of the above-obtained record. Accordingly, a new upper limit number is set to the setting value 634 of the upper limit number of API calls. The authorization API 304 returns a success (OK) to the application 331 as a response to the setting API for adding a number to the upper limit number of API calls.

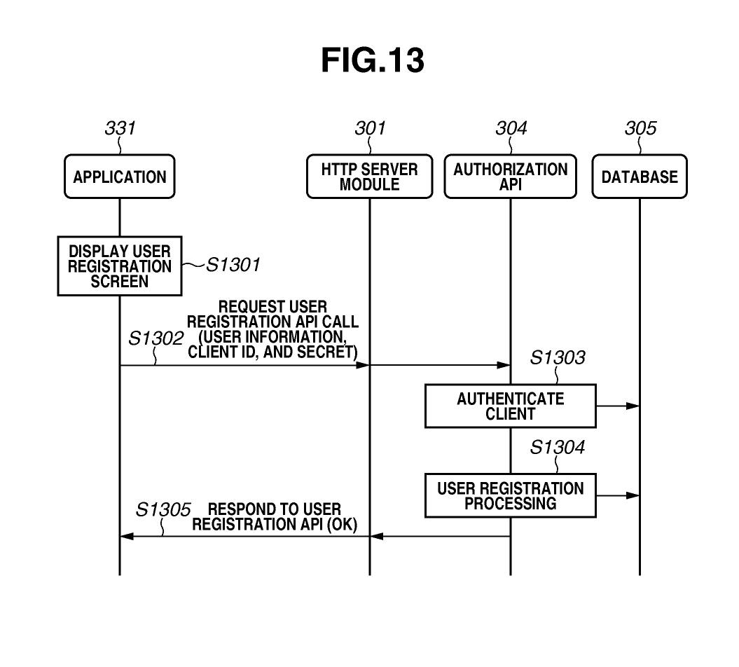

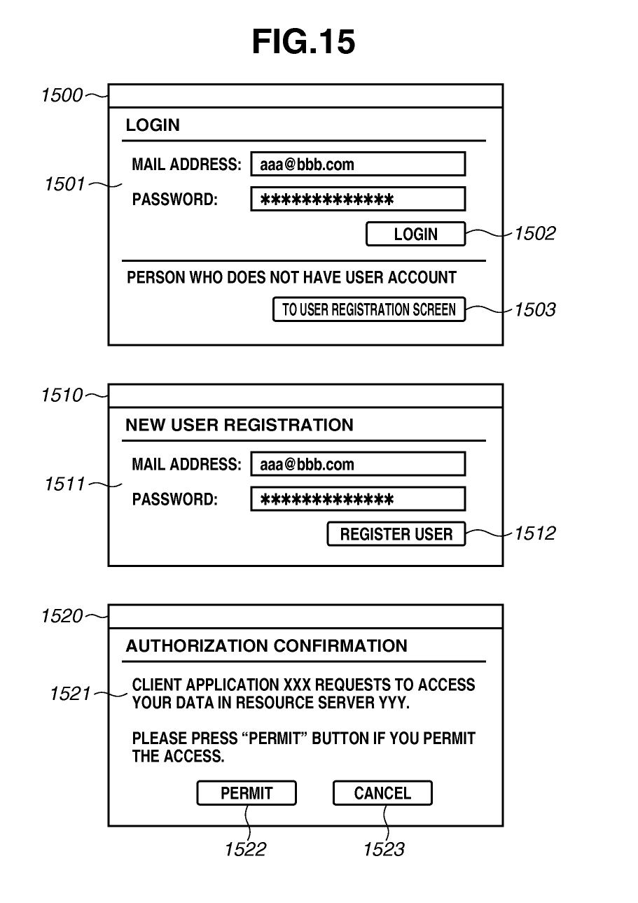

Next, a processing flow for issuing an authorization token based on Authorization Code Grant is described with reference to FIGS. 13, 14A, 14B, and 15. In step S1301, the application 331 displays a user registration screen 1510. The user registration screen 1510 may be displayed via a link 1503 to the user registration screen in a login screen 1500. When a user registration button 1512 is pressed, the application 331 obtains information pieces necessary for the user registration, such as a mail address and a password input by the user, from an input field 1511. In step S1302, the application 331 transmits a user registration API call request to the authorization API 304 using the obtained information, such as the mail address and the password, and the client ID and the secret stored in the above-described processing in step S907 as parameters. In step S1303, the authorization API 304 authenticates the request source client as is the case with the processing in step S909 using the received client ID and secret. The authorization API 304 specifies the tenant ID 613 of the client ID of the request source from the client management table 610. In step S1304, the authorization API 304 adds a record to the user management table 410 and respectively stores the specified tenant ID, the assigned user ID, the received mail address and password, and a general as the authority in the columns 411, 412, 413, 414, and 415. When the authorization API 304 succeeds in the user registration processing, then in step S1305, the authorization API 304 returns a response OK as a result of the user registration API call to the application 331.

In step S1401, the application 331 first checks whether the authorization token issued based on Authorization Code Grant is stored. When a determination result in step S1401 is YES, the processing proceeds to step S1422. When a determination result in step S1401 is NO, in step S1402, the application 331 transmits an authorization request to the authorization API 304 using the client ID and the redirect URL as parameters. In step S1403, the authorization API 304 verifies whether the received client ID exists in the client management table 610 and further verifies whether the received redirect URL coincides with the one registered in the column 616. When succeeding in verification in step S1403, then in step S1404, the authorization API 304 responds the application 331 with a redirect request to the login screen. In step S1405, the application 331 calls the browser 332 to display a subsequent screen and obtains and displays the login screen 1500 of a redirect destination. When a login button 1502 is pressed, in step S1406, the browser 332 transmits a login request to the authorization API 304 using a mail address and a password input to an input field 1501 as parameters.

In step S1407, the authorization API 304 searched the user management table 410 to verify whether the received mail address and password are correct and obtains the tenant ID 411 and the user ID 412 of the relevant user. When succeeding in the user authentication, in step S1408, the authorization API 304 responds the browser 332 with a redirect request to the authorization confirmation screen. In step S1409, the browser 332 obtains and displays an authorization confirmation screen 1520 of the redirect destination. The authorization confirmation screen 1520 displays an authorization confirmation message 1521 to clearly indicate which client requests access to which resource server. When a permission button 1522 or a cancel button 1523 is pressed, in step S1410, the browser 332 transmits an authorization operation result, namely permission or cancel, to the authorization API 304.

When cancel is received, the authorization API 304 cancels the authorization processing and terminates the processing by displaying a cancel screen or the like, which is not illustrated, on the browser 332. When permission is received, the authorization API 304 adds a record of which token type 621 is an authorization code to the authorization token management table 620. In step S1411, the authorization API 304 respectively stores a newly assigned authorization token ID, the expiration date of the authorization token, the client ID obtained in step S1402, and the user ID obtained in step S1407 in the columns 622, 623, 626, and 627. In step S1412, the authorization API 304 adds the authorization token ID of the generated authorization code to the redirect URL received in step S1403 and transmits it to the browser 332 as a response. In this regard, the redirect URL is set as a custom URL of the application 331 using a custom URL scheme, and the processing is returned to the application 331. In step S1413, the application 331 obtains the authorization token ID of the authorization code.

In step S1414, the application 331 transmits an authorization token request to the authorization API 304 using the client ID, the secret, and the authorization token ID of the authorization code as parameters. In step S1415, the authorization API 304 authenticates the client ID of the request source as is the case with the processing in step S909. The authorization API 304 searches the authorization token management table 620 to verify whether a record corresponding to the received authorization token ID of the authorization code exists. In step S1416, the authorization API 304 further verifies whether the expiration date 623 of the authorization token of the relevant record is within the valid period and whether the client ID 626 coincides with the client ID of the request source and obtains the user ID of the authorization code issuance destination registered in the owner ID 627.

In step S1417, the authorization API 304 searches the authorization token management table 620 to verify whether a record exists of which token type 621 is an authorization token and client ID 626 and owner ID 627 both coincide with the client ID of the request source. When a determination result in step S1417 is NO, the processing proceeds to step S1419. When a determination result in step S1417 is YES, in step S1418, the authorization API 304 forcibly rewrites the expiration date 623 of the authorization token of the record matching the search conditions in step S1417 into expired or deletes the record. Accordingly, if the client ID includes the authorization token issued based on Client Credentials Grant, the issued authorization token can be invalidated when the authorization token is switched to the one based on Authorization Code Grant. The authorization API 304 adds a record to the API call number management table 630. The authorization API 304 stores the user ID obtained in step S1416 in the user ID 631, “ALL” in the client ID 632, and the current period in the target period 633. In step S1419, the authorization API 304 stores in the setting value 634 the initial value 524 of the upper limit number of API calls per user ID of the relevant tenant of which target ID type 522 set in the tenant attribute information management table 520 is the user ID.

In step S1420, the authorization API 304 adds a record of which token type 621 is an authorization token to the authorization token management table 620. The authorization API 304 respectively stores a newly assigned authorization token ID, the expiration date of the authorization token, the refresh token ID, and the expiration date of the refresh token in the columns 622, 623, 624, and 625. Further, the authorization API 304 stores the client ID of the request source in the column 626 and the user ID obtained in step S1416 in the column 627. Furthermore, the authorization API 304 invalidates or deletes the record of the authorization code in the authorization token management table 620 which is verified in step S1416. In step S1421, the authorization API 304 responds the application 331 with the respective expiration dates of the authorization token ID and the refresh token ID as the authorization tokens.

In step S1422, the application 331 determines whether the authorization token currently stored is expired. When a determination result in step S1422 is NO, the processing proceeds to the resource request API call flow in step S1001. When a determination result in step S1422 is YES, in step S1423, the application 331 transmits an authorization token reissue request to the authorization API 304 using the client ID, the secret, and the refresh token ID as parameters. In step S1424, the authorization API 304 authenticates the client as is the case with the processing in step S1415. The authorization API 304 searches the authorization token management table 620 to verify whether a record corresponding to the received refresh token ID exists. In step S1425, the authorization API 304 further verifies whether the refresh token expiration date 625 of the relevant record is within the valid period and whether the client ID 626 coincides with the client ID of the request source and obtains the user ID of the authorization token issuance destination registered in the owner ID 627.

In step S1426, the authorization API 304 searches the API call number management table 630 and obtains the setting value 634 of the upper limit number of API calls of a record which includes the obtained user ID in the user ID 631, “ALL” in the client ID 632, and the current period in the target period 633. The authorization API 304 obtains from the API call number management table 630 a total value of the number of API calls 635 of the record which includes the obtained user ID in the user ID 631 and the current period in the target period 633. In step S1427, the authorization API 304 determines whether the total value of the obtained number of API calls 635 of the current month is equal to or less than the obtained setting value 634 of the upper limit number of API calls. When a determination result in step S1427 is NO, the processing proceeds to step S1430, and the authorization API 304 returns an error notifying that the number of API calls reaches the upper limit to the application 331 as a response. When a determination result in step S1427 is YES, the authorization API 304 adds a record of which token type 621 is an authorization token to the authorization token management table 620. The authorization API 304 respectively stores a newly assigned authorization token ID, the expiration date of the authorization token, the refresh token ID, and the expiration date of the refresh token in the columns 622, 623, 624, and 625. Further, the authorization API 304 stores the client ID of the request source in the column 626 and the user ID obtained in step S1425 in the column 627. Furthermore, in step S1428, the authorization API 304 invalidates or deletes the record corresponding to the refresh token ID verified in step S1425. In step S1429, the authorization API 304 responds the application 331 with the respective expiration dates of the authorization token ID and the refresh token ID as the authorization tokens.

Next, a resource request API call flow using the authorization token obtained in the authorization flow based on Authorization Code Grant is described. The flow is similar to that in FIGS. 10 and 16, and different parts are only described below. In the determination in step S1601, the owner ID will be the user ID in the case of Authorization Code Grant, and the processing proceeds to step S1605. In step S1605, the authorization API 304 obtains from the tenant attribute information management table 520 the operation mode 527 when the authorization flow is switched of a record which includes the tenant ID to which the request source client ID belongs in the column 521 and the user DI in the target ID type 522. In step S1606, the authorization API 304 checks the obtained operation mode 527. When the operation mode is 1, the processing proceeds to step S1607, and when the operation mode is 2, the processing proceeds to step S1609. In step S1607, the authorization API 304 searches the API call number management table 630 for the client ID of the authorization token issuance destination of which user ID is NULL and obtains the number of API calls 635 of the current month and the setting value 634 of the upper limit number of API calls.

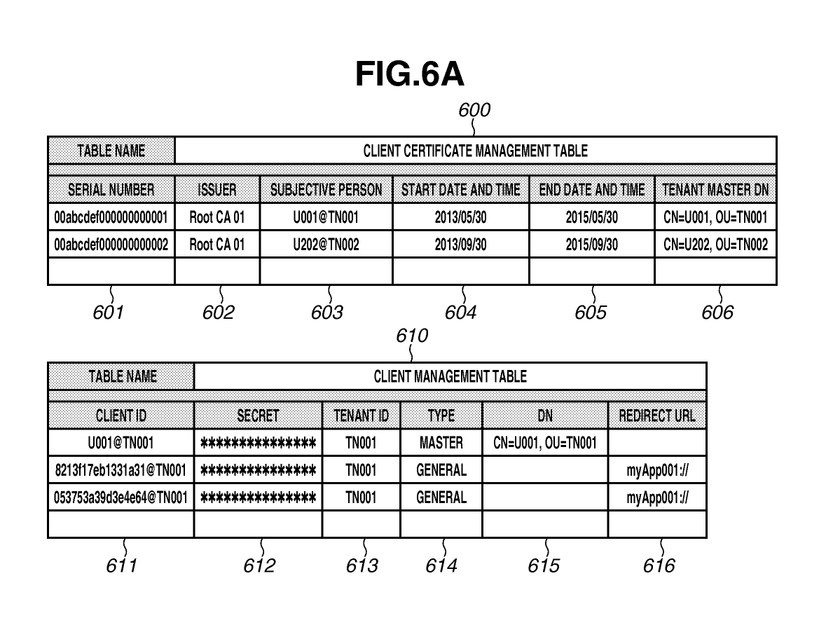

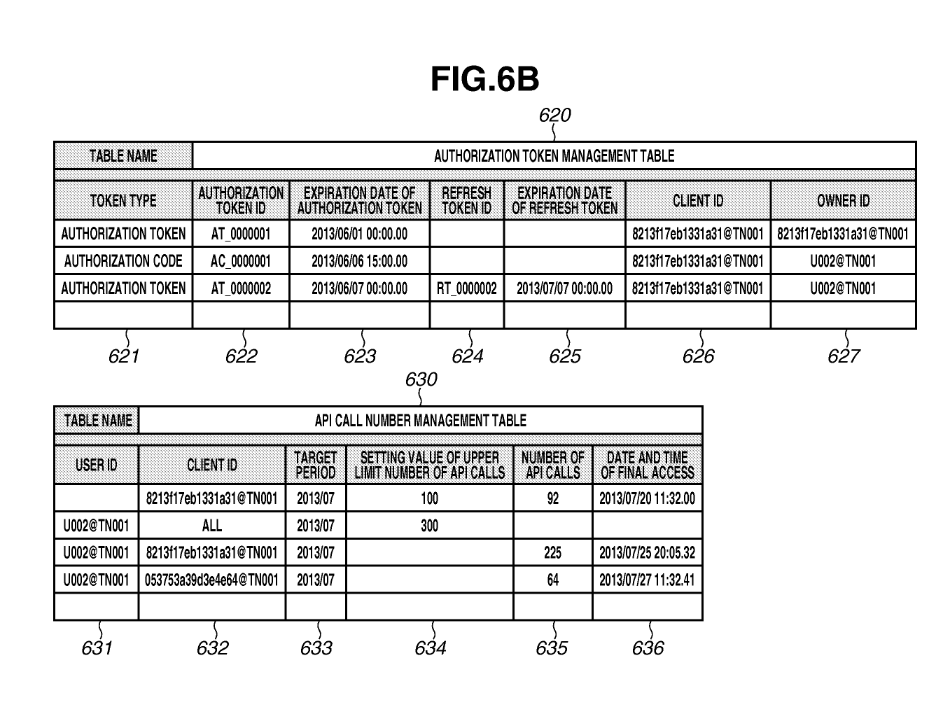

In step S1608, the authorization API 304 determines whether the number of API calls 635 of the current month is equal to or less than the setting value 634 of the upper limit number of API calls. When a determination result in step S1608 is YES, the processing proceeds to step S1604. When a determination result in step S1608 is NO, the processing proceeds to step S1609. The authorization API 304 performs the following processing as is the case with the processing in step S1426. In step S1609, the authorization API 304 obtains the setting value 634 of the upper limit number of API calls targeted at the user ID and a total value of the number of API calls 635 of a record of which user ID 631 and target period 633 are the obtained user ID and the current month. When an example of the total value is described based on FIG. 6, the numbers of API calls of the client ID associated with the user ID “U002@TN001” are “225” and “64”, so that the total value is “289”. In step S1610, the authorization API 304 determines whether the obtained total value of the number of API calls 635 of the current month is equal to or less than the obtained setting value 634 of the upper limit number of API calls, in other words, whether the total value is equal to or less than the upper limit number of API calls. When a determination result in step S1610 is YES, the processing proceeds to step S1611. In step S1611, the authorization API 304 obtains from the API call number management table 630 a record of which user ID 631 and client ID 632 are the owner ID obtained in step S1003 and the client ID of the authorization token issuance destination verified in step S1003. The authorization API 304 adds one to the number of API calls 635 of the current month of the obtained record. When a determination result in step S1610 is NO, the processing proceeds to step S1013.

When a single user uses a plurality of terminals, the client registration, the authorization token issuance, and the resource API call processing may be executed with respect to the second and subsequent terminals (client computers 122) in the similar way to the flows described with reference to FIGS. 9, 14, 10, and 16. Even if a single user uses a plurality of terminals, the upper limit number of API calls per user ID can be managed and limited by the processing in steps S1427 and S1610.

Next, a processing flow of addition to the upper limit number of API calls when the number of API calls per user ID reaches the upper limit is described. The flow is similar to that in FIG. 11, and different parts are only described below. In step S1106, the application 331 transmits to the authorization API 304 a user ID or a mail address which is a target of the addition to the upper limit number of API calls as additional parameters. The processing in step S1108 is changed to the following processing. The authorization API 304 reads a record of the relevant tenant ID of which target ID type 522 is the user ID from the tenant attribute information management table 520 and obtains the permission setting 525 of addition to the upper limit number of API calls. If the permission setting 525 is FALSE, the authorization API 304 returns an error response, which is not illustrated, to the application 331. The authorization API 304 reads a record of the tenant ID obtained in step S1107 from the tenant attribute information management table 520 and obtains the additional value 526 to the upper limit number of API calls per user ID of which target ID type 522 is the user ID. The authorization API 304 specifies a record which includes the user ID received as the additional parameter in the user ID 631, “ALL” in the client ID 632, and the current period in the target period 633 in the API call number management table 630. The authorization API 304 adds the obtained additional value 526 to the setting value 634 of the upper limit number of API calls of the specified record.

According to the first exemplary embodiment, the upper limit number of API calls assigned to one user can be shared among clients of a plurality of terminals without adding a function of managing the number of API calls to an application as the client.

According to the first exemplary embodiment, management and limitation of the number of API calls can be automatically switched from a unit of client ID to a unit of user ID when the authorization flow is switched from Client Credentials Grant to Authorization Code Grant. Further, according to the first exemplary embodiment, when the authorization flow is switched, the upper limit of the number of API calls can be increased at the same time for releasing the function limitation when, for example, an application is changed from free to charged. According to a second exemplary embodiment, the application 331 uses only the authorization flow of Authorization Code Grant without using that of Client Credentials Grant. All drawings are common to the first and second exemplary embodiments, and only differences between the second exemplary embodiment and the first exemplary embodiment are described below.

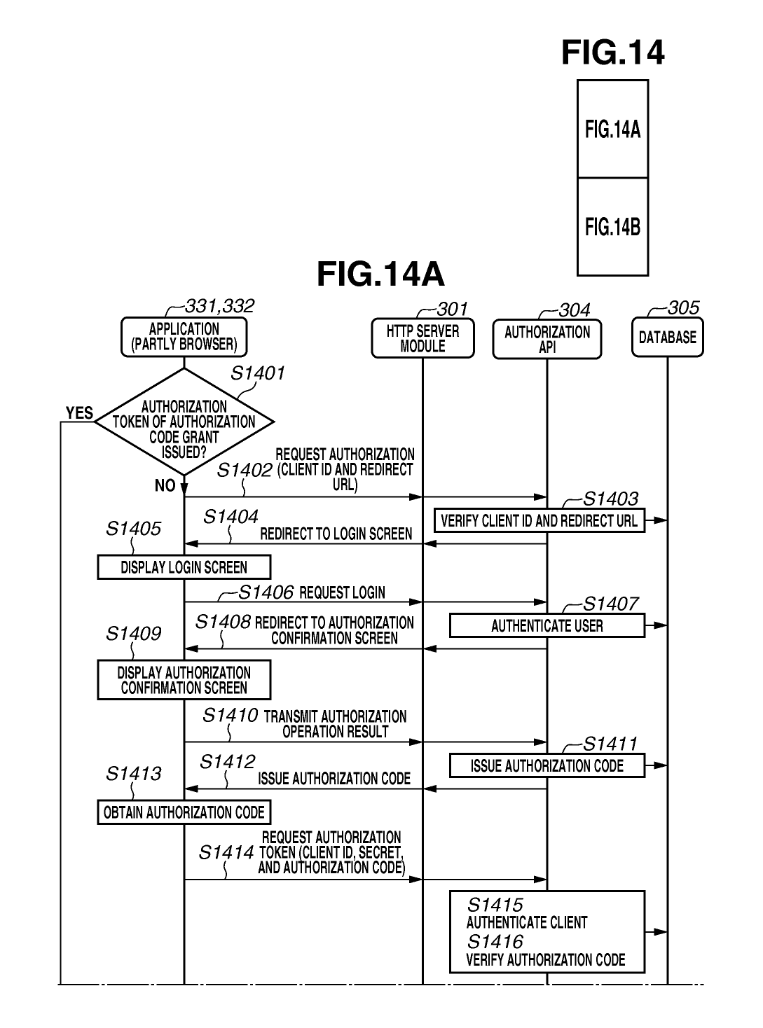

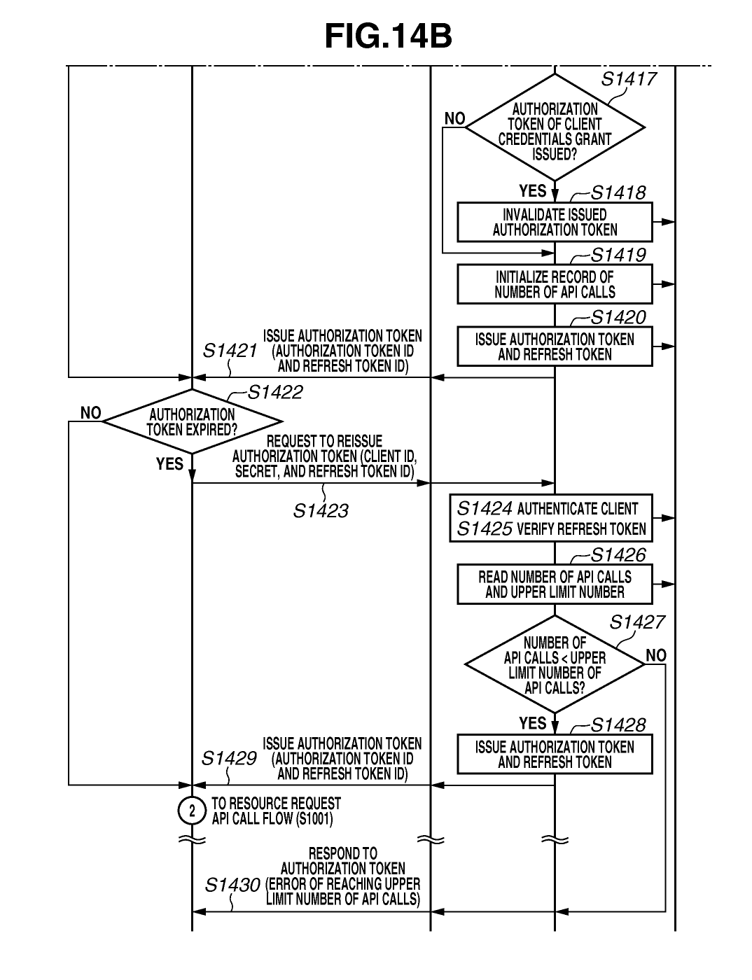

In FIG. 9, according to the second exemplary embodiment, the client registration processing in steps S901 to S907 is executed similarly to that in the first exemplary embodiment, but the processing in steps S908 to S914 is not executed. In FIGS. 13 and 14, the user registration and the authorization token issuance processing based on Authorization Code Grant are executed similarly to those in the first exemplary embodiment. In FIG. 10, according to the second exemplary embodiment, the resource request API call processing in steps S1001 to S1014 is executed similarly to that in the first exemplary embodiment. In FIG. 16, according to the second exemplary embodiment, Client Credentials Grant is not used by the same client ID, so that the processing in steps S1605 to S1608 is not necessary, and the processing in step S1609 and subsequent steps is executed.

When a single user uses a plurality of terminals, the processing similar to that in the first exemplary embodiment is executed in the second and subsequent terminals (the client computers 122). According to the second exemplary embodiment, management and limitation of the number of API calls with respect to a plurality of the applications 331 authorized by Authorization Code Grant can be executed in a unit of user ID.

As described above in the first and second exemplary embodiments, the authorization server 111 provides API authorization conforming to the OAuth 2.0 authorization flow with respect to an API utilization request from the resource server to the API 313. Especially, the client ID can be identified in each application 331 in the client computer 122, and the number of API calls to the API 313 from the resource server 112 can be managed and limited per client ID or per user ID. In addition, when the authorization token is issued and when the authorization token is verified, which are essential processing in the OAuth 2.0 authorization flow, attainment to the upper limit of the number of API calls can be verified per client ID or per user ID of the authorization token issuance destination. Accordingly, an application developer can control the number of API calls from the distributed application 331 by himself or herself using settings in the table 520 and the screen 810 of each tenant in the authorization server 111.

Regarding the authorization flow from the application 331, when it is that of Client Credentials Grant, the number of API calls is automatically managed and limited per client ID, and when it is that of Authorization Code Grant, the number of API calls is automatically managed and limited per user ID. In addition, in the case that the upper limit number of API usage is increased with respect to all of a plurality terminals owned by a same user to release the function limitation when the application is switched from free to charged, which is described in the issue at the beginning, convenience of BaaS is not impaired. It is because that the management and limitation of the number of API calls is automatically switched from a unit of client ID to a unit of user ID when the authorization flow is switched from Client Credentials Grant to Authorization Code Grant. Thus, it is necessary for the application developer to only implement two types of authorization flows exactly as standard of OAuth 2.0 to the application 331, and there is no need to implement special processing to increase the upper limit number of API usage. Accordingly, the Web service providing system including the authorization server 111 and others can achieve effects of solving the issue described at the beginning.

The above-described exemplary embodiment(s) can provide a mechanism which enables an application developer to easily use an API without impairing convenience of BaaS in a case that a single end user uses a same application function from a plurality of terminals.

### Other Embodiments

Additional exemplary embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-122538, filed Jun. 13, 2014, which is hereby incorporated by reference herein in its entirety.

What is claimed is:

1. A system including a server system including a service available from a client and a client who uses the service by calling an application programming interface for using the service, the system comprising:
an authentication unit configured to determine whether the client is an authorized client based on a client identifier assigned to the client;
an issuance unit configured to issue authority information indicating that the client has authority to use the service in response to a determination that the client is an authorized client;
an authorization unit configured to authorize the client to use the service based on the authority information transmitted by the client when calling the application programming interface; and
a storage unit configured to associate the authority information with a user identifier and store the user identifier and an upper limit number of calls of the application programming interface in association with each other,
wherein the authorization unit specifies a user identifier associated with the authority information transmitted from the client and permits the client to use the service in a case where a total of the application programming interface calls that a plurality of clients, including the client, called the application programming interface by an instruction from a user corresponding to the user identifier is less than or equal to the upper limit number of application programming interface calls associated with the user identifier.

2. The system according to claim 1, wherein the authorization unit specifies a user identifier associated with the authority information transmitted from the client and does not permit the client to use the service in a case where a total of the application programming interface calls that a plurality of clients, including the client, called the application programming interface by an instruction from a user corresponding to the user identifier exceeds the upper limit number of application programming interface calls associated with the user identifier.

3. The system according to claim 1, wherein in a case where a total of the application programming interface calls that a plurality of clients, including the client, called the application programming interface by an instruction from a user corresponding to the user identifier exceeds the upper limit number of application programming interface calls associated with the user identifier and a client, who is permitted to add to the upper limit number of application programming interface calls, requests addition to the upper limit number, the storage unit adds a number to the upper limit number of application programming interface calls associated with the user identifier.

4. The system according to claim 1, wherein, in a case where the authority information with respect to the client is reissued, the issuance unit specifies a user identifier associated with information necessary for reissuing the authority information transmitted from the client and reissues authority information indicating that the client has authority to use the service if a total of the application programming interface calls that a plurality of clients, including the client, called the application programming interface by an instruction from a user corresponding to the user identifier is less than or equal to the upper limit number of application programming interface calls associated with the user identifier.

5. The system according to claim 1, wherein, in a case where the authority information with respect to the client is reissued, the issuance unit specifies a user identifier associated with information necessary for reissuing the authority information transmitted from the client and does not reissue authority information indicating that the client has authority to use the service if a total of the application programming interface calls that a plurality of clients, including the client, called the application programming interface by an instruction from a user corresponding to the user identifier exceeds the upper limit number of application programming interface calls associated with the user identifier.

6. A method executed by a system including a server system including a service available from a client and a client who uses the service by calling an application programming interface for using the service, the method comprising:
determining whether the client is an authorized client based on a client identifier assigned to the client;
issuing authority information indicating that the client has authority to use the service in response to a determination that the client is an authorized client;
authorizing the client to use the service based on the authority information transmitted by the client when calling the application programming interface;
associating the authority information with a user identifier;
storing the user identifier and an upper limit number of calls of the application programming interface in association with each other;
specifying a user identifier associated with the authority information transmitted from the client; and
permitting the client to use the service in a case where a total of the application programming interface calls that a plurality of clients, including the client, called the application programming interface by an instruction from a user corresponding to the user identifier is less than or equal to the upper limit number of application programming interface calls associated with the user identifier.

7. The method according to claim 6, further comprising specifying a user identifier associated with the authority information transmitted from the client and not permitting the client to use the service in a case where a total of the application programming interface calls that a plurality of clients, including the client, called the application programming interface by an instruction from a user corresponding to the user identifier exceeds the upper limit number of application programming interface calls associated with the user identifier.

8. The method according to claim 6, further comprising adding, in a case where a total of the application programming interface calls that a plurality of clients, including the client, called the application programming interface by an instruction from a user corresponding to the user identifier exceeds the upper limit number of application programming interface calls associated with the user identifier and a client, who is permitted to add to the upper limit number of application programming interface calls, requests addition to the upper limit number, a number to the upper limit number of application programming interface calls associated with the user identifier.

9. The method according to claim 6, further comprising, in a case where the authority information with respect to the client is reissued, specifying a user identifier associated with information necessary for reissuing the authority information transmitted from the client and to reissue authority information indicating that the client has authority to use the service if a total of the application programming interface calls that a plurality of clients, including the client, called the application programming interface by an instruction from a user corresponding to the user identifier is less than or equal to the upper limit number of application programming interface calls associated with the user identifier.

10. The method according to claim 6, further comprising, in a case where the authority information with respect to the client is reissued, specifying a user identifier associated with information necessary for reissuing the authority information transmitted from the client and not reissuing authority information indicating that the client has authority to use the service if a total of the application programming interface calls that a plurality of clients, including the client, called the application programming interface by an instruction from a user corresponding to the user identifier exceeds the upper limit number of application programming interface calls associated with the user identifier.

11. A computer-readable storage medium storing computer executable instructions for causing a server system, including a service available from a client who uses the service by calling an application programming interface for using the service, to execute a method, the method comprising:
determining whether the client is an authorized client based on a client identifier assigned to the client;
issuing authority information indicating that the client has authority to use the service in response to a determination that the client is an authorized client;
authorizing the client to use the service based on the authority information transmitted by the client when calling the application programming interface;
associating the authority information with a user identifier;
storing the user identifier and an upper limit number of calls of the application programming interface in association with each other;
specifying a user identifier associated with the authority information transmitted from the client; and
permitting the client to use the service in a case where a total of the application programming interface calls that a plurality of clients, including the client, called the application programming interface by an instruction from a user corresponding to the user identifier is less than or equal to the upper limit number of application programming interface calls associated with the user identifier.
